(19) United States
(12) Patent Application Publication
(10) Pub. No.: US 2020/0133082 A1
(43) Pub. Date: Apr. 30, 2020

(54) LIQUID CRYSTAL DISPLAY PANEL AND MANUFACTURING METHOD THEREOF

(71) Applicants: Yuan SHAO, Shenzhen, Guangdong (CN); Min TANG, Shenzhen, Guangdong (CN); Hsiao Hsien CHEN, Shenzhen, Guangdong (CN)

(72) Inventors: Yuan SHAO, Shenzhen, Guangdong (CN); Min TANG, Shenzhen, Guangdong (CN); Hsiao Hsien CHEN, Shenzhen, Guangdong (CN)

(21) Appl. No.: 15/749,488

(22) PCT Filed: Jan. 10, 2018
(86) PCT No.: PCT/CN2018/072016

§ 371 Date: Nov. 6, 2018

(30) Foreign Application Priority Data
Sep. 6, 2017 (CN) 201710797225.8

(51) Int. Cl. G02F 1/1362; G02F 1/1335

(52) U.S. Cl. CPC G02F 1/136209; G02F 2001/133357; G02F 2001/133562; G02F 1/133528

(57) ABSTRACT

A liquid crystal display panel comprising an array substrate, a color filter substrate, a liquid crystal layer interposed between the array substrate and the color filter substrate, and a light shielding layer is provided. The array substrate is located at an illuminating side of the liquid crystal display panel, and has metal electrode lines disposed on an interior surface thereof. The light shielding layer is located on an exterior surface of the array substrate. A projection of a pattern of the light shielding layer on the array substrate at least covers a portion of the metal electrode lines. A manufacturing method of the liquid crystal display panel is also provided. The present invention has the side with the array substrate as the illuminating side, and places the light shielding layer on the exterior surface of the array substrate to reduce reflection of the metal electrode lines.

### RELATED APPLICATIONS

The present application is a National Phase of International Application Number PCT/CN2018/072016, filed Jan. 10, 2018, and claims the priority of China Application No. 201710797225.8, filed Sep. 6, 2017.

### BACKGROUND OF THE INVENTION

### 1. Field of the Invention

The present invention is related to liquid crystal display technology, and more particularly is related to a liquid crystal display panel and a manufacturing method thereof.

### 2. The Related Arts

Attending with the increasing demand of displays, new technologies have emerged, but brightness and contrast of display panels is still an important factor for judging overall display quality of the display. As the contrast is improved, a better overall color presentation and display effect of the display panel would be resulted. Thus, it has become a key topic for the research nowadays to find out the way for improving contrast of the display panel. Regarding the ways for improving contrast, besides the method of increasing brightness of the illumination unit, it is also an important aspect to the research to find out the way to reduce reflection of environmental light.

The display panel of the conventional display includes an exterior color filter (CF) substrate and an interior thin film transistor (TFT) substrate, wherein the side with the CF substrate is the illuminating side of the display panel. Because of the environmental light projected into the display panel, a mirror-like effect would be happened on the array substrate of the conventional display because of the existence of metal signal lines for reflecting the environmental light, such that the contrast as well as the overall display quality would be affected.

### SUMMARY

In view of the drawbacks of the conventional technologies, a liquid crystal display panel and a manufacturing method thereof is provided in the present invention, which is capable to reduce the reflection of the environmental light so as to enhance contrast of the liquid crystal display panel.

In order to achieve the aforementioned object, a liquid crystal display panel is provided in the present invention.

The liquid crystal display panel comprises an array substrate, a color filter substrate, a liquid crystal layer interposed between the array substrate and the color filter substrate, and a light shielding layer. The array substrate is located at an illuminating side of the liquid crystal display panel. The array substrate has metal electrode lines disposed on an interior surface thereof. The light shielding layer is located on an exterior surface of the array substrate. A projection of a pattern of the light shielding layer on the array substrate at least covers a portion of the metal electrode lines.

In accordance with an embodiment of the liquid crystal display panel of he present invention, the light shielding layer is a black ink layer.

In accordance with an embodiment of the liquid crystal display panel of the present invention, the light shielding layer is formed on the array substrate by using a lithographic process.

In accordance with an embodiment of the liquid crystal display panel of the present invention, the projection of the pattern of the light shielding layer on the array substrate fully covers the metal electrode lines.

In accordance with an embodiment of the liquid crystal display panel of the present invention, the light shielding layer is a black matrix, and the projection of the light shielding layer on the array substrate surrounds each pixel.

In accordance with an embodiment of the liquid crystal display panel of the present invention, a line width of the light shielding layer is greater than a line width of the corresponding metal electrode line.

In accordance with an embodiment of the liquid crystal display panel of the present invention, the liquid crystal display panel further comprises a planarization layer, which is located on the exterior surface of the array substrate and fills openings of the light shielding layer.

In accordance with an embodiment of the liquid crystal display panel of the present invention, the liquid crystal display panel further comprises an upper polarizer, which is attached to an exterior surface of the planarization layer.

A manufacturing method of a liquid crystal display panel is provided in accordance with another object of the present invention. The manufacturing method comprises the steps of: providing a substrate; depositing a light shielding material on a whole surface of the substrate; patterning the light shielding material to form a light shielding layer; forming metal electrode lines and TFT components on another surface of the substrate to compose the array substrate; and having the surface of the array substrate with the TFT components facing interior, and integrating the array substrate and a color filter substrate without a black matrix to form the liquid crystal display panel; wherein the pattern of the light shielding layer on the substrate fully covers the metal electrode lines.

In accordance with an embodiment of the manufacturing method of the present invention, after the formation of the light shielding layer, further comprises the step of: forming a transparent planarization layer on the substrate and having the transparent planarization layer filling openings of the light shielding layer, and attaching an upper polarizer on a surface of the planarization layer.

By using the side with the array substrate as the illuminating side and the side with the color filter substrate as a light incident surface and placing the light shielding layer on the exterior surface of the array substrate corresponding to the metal electrode lines located on the interior surface thereof, the present invention is capable to absorb the environmental light projected to the metal electrode lines located on the interior surface of the array substrate by using the light shielding layer such that reflection by the metal electrode lines can be reduced so as to enhance contrast of the liquid crystal display and also the display quality.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures;

FIG. 1 is a schematic top view of a liquid crystal display panel in accordance with an embodiment of the present invention;

FIG. 2 is a schematic view showing the internal structure of the liquid crystal display panel in accordance with an embodiment of the present invention;

FIG. 3 is a schematic view showing the manufacturing process of the liquid crystal display panel in accordance with an embodiment of the present invention;

FIG. 4 is a flow chart showing the manufacturing method of the liquid crystal display panel in accordance with an embodiment of the present invention.

### DETAILED DESCRIPTION OF THE PREFERRED EMBODIMENTS

In order to understand the above objectives, features and advantages of the present disclosure more clearly, the present disclosure is described in detail below with references to the accompanying drawings and specific embodiments. It should be understood that the specific embodiments described herein are only intended to illustrate the present invention and are not intended to limit the present invention.

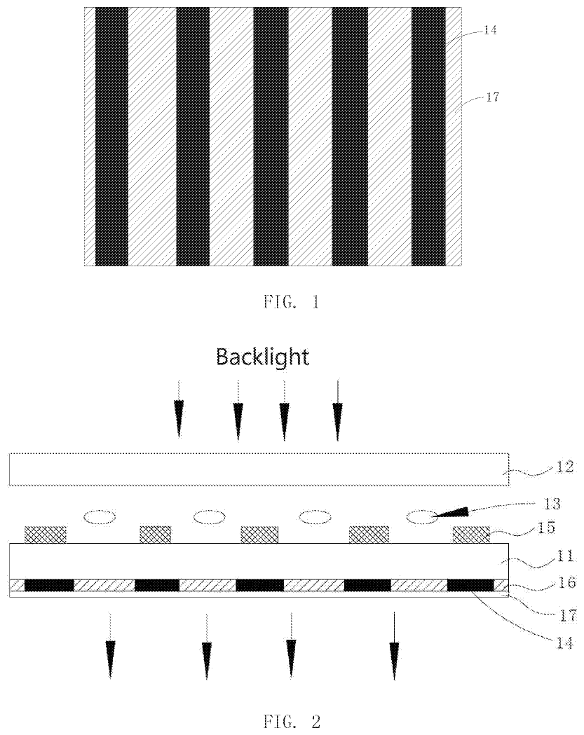

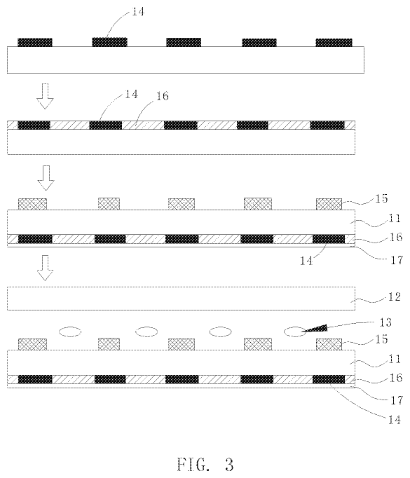

Please refer to FIG. 1, the liquid crystal display panel of the present embodiment includes an array substrate 11, a color filter substrate 12, a liquid crystal layer 13 filled between the array substrate 11 and the color filter substrate 12, and a light shielding layer 14. The array substrate 11 is located at the illuminating side of the liquid crystal display panel. The array substrate 11 has metal electrode lines 15 disposed on an interior surface thereof. The light shielding layer 14 is located on an exterior surface of the array substrate 11. A projection of a pattern of the light shielding layer 14 on the array substrate 11 at least covers a portion of the metal electrode lines 15, meanwhile, the color filter substrate 12 is arranged without the black matrix layer.

Because the side with the array substrate 11 is used as the illuminating side and the backlight enters the panel from the side with the color filter substrate 12, the display image would be watched from the side with the array substrate 11. At the same time, environmental light would be projected into the panel from the array substrate 11 toward the color filter substrate 12. Because the projection of the pattern of the light shielding layer 14 on the array substrate 11 covers at least a portion of the metal electrode lines 15, some of the environmental light entering the panel would be absorbed by the light shielding layer 14, such that reflection of the environmental light by the metal electrode lines 15, such as gate lines and data lines, can be weakened to prevent generation of mirror effect. In this embodiment, the effect of preventing the environmental light from projected to the metal electrode lines 15 can be maximized if the projection of the pattern of the light shielding layer 14 on the array substrate 11 fully covers the metal electrode lines 15.

As shown in FIG. 1, in the array substrate 11, only the gate lines are the metal electrode lines, and the other electrode lines are the transparent electrode lines. The light shielding layer 14 includes a plurality of light shielding stripes parallel with each other, and the width of each stripe is no smaller than the width of the gate line. In this embodiment, the metal electrode lines 15 may include, but is not limited to, the data lines, the gate lines, the touch-control electrode lines (such as the touch-control driving electrode Tx and the touch-control sensing electrode Rx), and etc., and the pattern of the light shielding layer 14 differs in responsive to the layout of the metal lines in practice. For example, if both the data lines and the gate lines are metal electrode lines, the light shielding layer 14 may include the light shielding stripes interest with each other to form a mesh shape acting as a black matrix, and the projection of the light shielding layer 14 may surround the boundary of each pixel. In addition, for example, if the liquid crystal display panel is an in-cell display panel, the metal electrode lines 15 may further include the touch-control electrode lines, and the light shielding layer 14 is also utilized for shielding the portion of the touch-control electrode lines.

In the present embodiment, the light shielding layer 14 is a black ink layer, the array substrate 11 is a flexible substrate, and the light shielding layer 14 is formed on the array substrate 11 by using a lithographic process. The line width of the light shielding layer 14 is greater than the line width of the exactly corresponding metal electrode line 15. The light shielding layer 14 can be made of a light absorbing material such as indium tin oxide (ITO), or black epoxy material. The thickness of the light shielding layer 14 is between 1˜3 μm, and the line width of the light shielding layer 14 is between 15˜25 μm.

The liquid crystal display panel also has a transparent planarization layer 16 and an upper polarizer 17 on an exterior surface thereof. The planarization layer 16 is located on the exterior surface of the array substrate 11 and fills the openings of the light shielding layer 14. The planarization layer 16 can be a transparent photo-resist layer to provide a better planarization effect. The planarization layer 16 lines up with the outer surface of the light shielding layer 14 so as to planarize the surface of the light shielding layer 14 for adhering the upper polarizer 17. The upper polarizer 17 is adhered on both the exterior surfaces of the light shielding layer 14 and the planarization layer 16. In addition, besides filling the openings of the light shielding layer 14, the planarization layer 16 may further cover the surface of the light shielding layer 14 as a protection.

By using the side with the array substrate 11 as the illuminating side, the bonding area extended from one side of the array substrate 11 for locating the driver IC is facing inward and is invisible by the viewer from the outside. Thus, it would be unnecessary to shield the bonding area for keeping the appearance attractive by using the frame specifically. This feature is beneficial to the implementation of narrow frame design of the liquid crystal display panel. Moreover, the light shielding layer 14 is located on the exterior surface of the array substrate 11. The light shielding layer 14 can be functioned as a black matrix such that the black matrix at the interior side of the color filter substrate 12 can be skipped, and thus the liquid crystal display panel can be thinner and the amount of liquid crystal used in the panel can be reduced correspondingly.

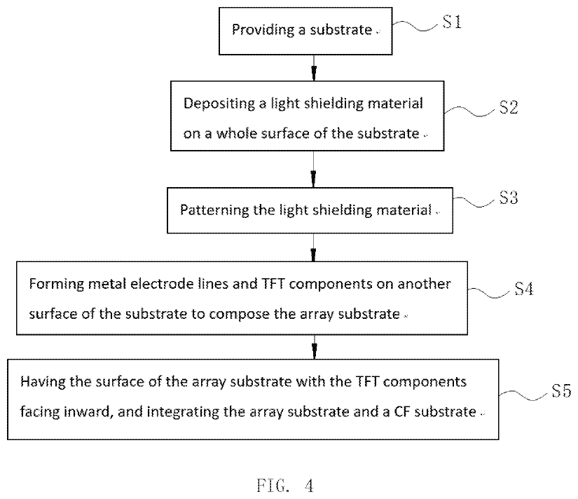

As shown in FIG. 3 and FIG. 4, the manufacturing method of the liquid crystal display panel in the present invention mainly includes the following steps.

S1. Providing a substrate.

S2. Depositing a light shielding material on a whole surface of the substrate.

S3. Patterning the light shielding material to form a light shielding layer.

S4. Forming metal electrode lines and TFT components on another surface of the substrate to compose the array substrate.

S5. Having the surface of the array substrate with the TFT components facing inward, and integrating the array substrate and the color filter CF substrate without a black matrix to form the liquid crystal display panel.

It should be noted that after the manufacturing process is completed, the projection of the pattern of the light shielding layer on the substrate at least covers a portion of the metal electrode lines 15, and it is preferred to have the pattern of the light shielding layer exactly corresponding to and fully cover the metal electrode lines, i.e. the projection of the pattern of the light shielding layer 14 on the array substrate 11 fully covers the metal electrode lines 15.

The substrate used in step S1 can be a glass substrate or various types of flexible substrates. Before the steps of forming the metal electrode lines or depositing the light shielding material on the substrate, it is common to clean and dry the substrate to prevent adhesion of impurities, such as dust. In Step S2, the thickness of the light shielding material is between 1˜3 μm, and the width of the light shielding layer 14 is between 15˜25 μm. In Step S3, the light shielding material is patterned by using the lithographic process, which forms a photoresist layer on the surface of the light shielding material, executes the steps such as exposing, developing, etching and etc., by using the mask with the pattern matching the pattern of the metal electrode lines 15, so as to form the light shielding layer 14 with the predetermined pattern on the surface of the substrate.

After the formation of the light shielding layer, the process further comprises the step of forming a transparent planarization layer 16 on the substrate and having the transparent planarization layer 16 filling openings of the light shielding layer 14, and adhering an upper polarizer 17 on a surface of the planarization layer 16. Basically, this step is executed after the step S3.

By using the side with the array substrate as the illuminating side and the side with the color filter substrate as a light incident surface and placing the light shielding layer on the exterior surface of the array substrate corresponding to the metal electrode lines located on the interior surface thereof, the present invention is capable to absorb the environmental light projected to the metal electrode lines located on the interior surface of the array substrate by using the light shielding layer, such that reflection by the metal electrode lines can be reduced so as to enhance contrast of the liquid crystal display and also the display quality.

What is claimed is:

1. A liquid crystal display panel, comprising an array substrate, a color filter substrate, a liquid crystal layer interposed between the array substrate and the color filter substrate, and a light shielding layer, wherein the array substrate is located at an illuminating side of the liquid crystal display panel, the array substrate has metal electrode lines disposed on an interior surface thereof, the light shielding layer is located on an exterior surface of the array substrate, and a projection of a pattern of the light shielding layer on the array substrate at least covers a portion of the metal electrode lines.

2. The liquid crystal display panel of claim 1, wherein the light shielding layer is a black ink layer.

3. The liquid crystal display panel of claim 2, wherein the light shielding layer is formed on the array substrate by using a lithographic process.

4. The liquid crystal display panel of claim 1, wherein the projection of the pattern of the light shielding layer on the array substrate fully covers the metal electrode lines.

5. The liquid crystal display panel of claim 1, wherein the light shielding layer is a black matrix, and the projection of the light shielding layer on the array substrate surrounds each pixel.

6. The liquid crystal display panel of claim 4, wherein a line width of the light shielding layer is greater than a line width of the corresponding metal electrode line.

7. The liquid crystal display panel of claim 1, further comprising a planarization layer, located on the exterior surface of the array substrate and filling openings of the light shielding layer.

8. The liquid crystal display panel of claim 7, further comprising an upper polarizer, attached to an exterior surface of the planarization layer.

9. The liquid crystal display panel of claim 4, further comprising a transparent planarization layer, located on the exterior surface of the array substrate and filling openings of the light shielding layer.

10. The liquid crystal display panel of claim 9, further comprising an upper polarizer, attached to an exterior surface of the planarization layer.

11. The liquid crystal display panel of claim 5, further comprising a transparent planarization layer, located on the exterior surface of the array substrate and filling openings of the light shielding layer.

12. The liquid crystal display panel of claim 11, further comprising an upper polarizer, attached to an exterior surface of the planarization layer.

13. The liquid crystal display panel of claim 6, further comprising a transparent planarization layer, located on the exterior surface of the array substrate and filling openings of the light shielding layer.

14. The liquid crystal display panel of claim 13, further comprising an upper polarizer, attached to an exterior surface of the planarization layer.

15. A manufacturing method of a liquid crystal display panel, comprising the steps of:
providing a substrate;
depositing a light shielding material on a whole surface of the substrate;
patterning the light shielding material to form a light shielding layer;
forming metal electrode lines and thin film transistor (TFT) components on another surface of the substrate to compose the array substrate;
having the surface of the array substrate with the TFT components facing interior, and integrating the array substrate and a color filter (CF) substrate without a black matrix to form the liquid crystal display panel;
wherein a projection of a pattern of the light shielding layer on the substrate at least covers a portion of the metal electrode lines.

16. The manufacturing method of the liquid crystal display panel of claim 15, wherein after the formation of the light shielding layer, further comprises the step of: forming a transparent planarization layer on the substrate and having the transparent planarization layer filling openings of the light shielding layer, and attaching an upper polarizer on a surface of the planarization layer.

17. The manufacturing method of the liquid crystal display panel of claim 15, wherein the projection of the pattern of the light shielding layer on the substrate fully covers the metal electrode lines.

18. The manufacturing method of the liquid crystal display panel of claim 16, wherein before the steps of forming the metal electrode lines or depositing the light shielding material on the substrate, further comprises the step of cleaning and drying the substrate.

19. The manufacturing method of the liquid crystal display panel of claim 16, wherein a thickness of the deposited light shielding material is 1˜3 μm, and a line width of the light shielding layer is 15˜25 μm.
